(19) United States
(12) Patent Application Publication
(10) Pub. No.: US 2025/0227208 A1
(43) Pub. Date: Jul. 10, 2025

(54) PROJECTION DEVICE AND USE METHOD THEREOF

(71) Applicant: Coretronic Corporation, Hsin-Chu (TW)

(72) Inventors: Chun-Chieh Wang, Hsin-Chu (TW); Fan-Chieh Chang, Hsin-Chu (TW); Chen-Yi Hong, Hsin-Chu (TW)

(73) Assignee: Coretronic Corporation, Hsin-Chu (TW)

(21) Appl. No.: 19/006,043

(22) Filed: Dec. 30, 2024

(30) Foreign Application Priority Data
Jan. 4, 2024 (CN) 202410011182.6

(51) Int. Cl. H04N 9/31

(52) U.S. Cl. CPC H04N 9/3152; H04N 9/3185

(57) ABSTRACT

A projection device comprising an optical engine module, a lens module, a sensing module and a control module is provided. The lens module includes a first lens, a second lens and a switch module. The switch module connects the first lens and the second lens to switch the positions of the first lens and the second lens relative to the optical engine module. The sensing module includes a first sensing element. The first sensing element is configured to sense a distance between the projection device and the projection target to obtain a distance signal. The control module is configured to receive the distance signal from the first sensing element, and control the switch module according to the distance signal, so that the switch module switches one of the first lens and the second lens to the transmission path of the image beam.

### CROSS-REFERENCE TO RELATED APPLICATION

This application claims the priority benefit of China application serial no. 202410011182.6, filed on Jan. 4, 2024. The entirety of the above-mentioned patent application is hereby incorporated by reference herein and made a part of this specification.

### BACKGROUND

### Technical Field

The disclosure relates to an electronic device; more particularly, the disclosure relates to a projection device and a use method thereof.

### Description of Related Art

As technology strides forward, a projection device standing as a display device for generating expansive images undergoes a continual evolution. Fundamentally, the imaging mechanism of the projection device is to convert an illumination beam emitted by an illumination system into an image beam via a light valve. Subsequently, the image beam is projected onto a designated target (e.g., a screen or a wall) by means of a projection lens module, thereby forming a desired image. Besides, the illumination system has witnessed a progression from ultra-high-performance (UHP) lamps and light-emitting diodes (LEDs) to the cutting-edge laser diode (LD) light sources. What is more, the introduction of multi-in-one packaged light sources, forged from the LD, has contributed to a more streamlined internal configuration of the projection device, enhancing its optical performance. These advancements align with market demands for heightened brightness, enriched color saturation, prolonged service life, and environmentally-friendly attributes within projection devices.

However, in current projection devices, a lens of the projection lens module is fixedly installed and can only be used in one way after installation. Therefore, if it is limited by site environmental factors, it will not be widely used.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a projection device, comprising an optical engine module, a lens module, a sensing module and a control module. The optical engine module is configured to provide an image beam. The lens module is configured on a transmission path of the image beam to project the image beam to a projection target outside the projection device. The lens module includes a first lens, a second lens and a switch module. The switch module connects the first lens and the second lens to switch the positions of the first lens and the second lens relative to the optical engine module. The sensing module includes a first sensing element. The first sensing element is configured to sense a distance between the projection device and the projection target to obtain a distance signal. The control module is electrically connected to the sensing module and the switch module. The control module is configured to receive the distance signal from the first sensing element, and control the switch module according to the distance signal, so that the switch module switches one of the first lens and the second lens to the transmission path of the image beam.

Another embodiment of the disclosure provides a use method of the projection device, the steps of the use method of the projection device comprising: projecting the image beam to the projection target; sensing a distance between the projection device and the projection target to obtain the distance signal; and controlling the switch module according to the distance signal, so that the switch module switches one of the first lens and the second lens to the transmission path of the image beam.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B are respectively a schematic block diagram and a schematic structural diagram illustrating a projection device using a first lens according to an embodiment of the disclosure.

FIG. 2A and FIG. 2B are respectively a schematic block diagram and a schematic structural diagram illustrating a projection device using a second lens according to an embodiment of the disclosure.

FIG. 3 is a schematic view of projections of the first lens and the second lens according to an embodiment of the disclosure.

FIG. 4 is a schematic block diagram of a projection device according to another embodiment of the disclosure.

FIG. 5 is a schematic block diagram of a projection device according to another embodiment of the disclosure.

FIG. 6 is a flowchart of steps of a use method of a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure is directed to a projection device and a use method thereof, which eliminates the need to manually change lenses and improves the convenience of use of the projection device and its application fields.

Additional aspects and advantages of the disclosure will be set forth in the description of the techniques disclosed in the disclosure.

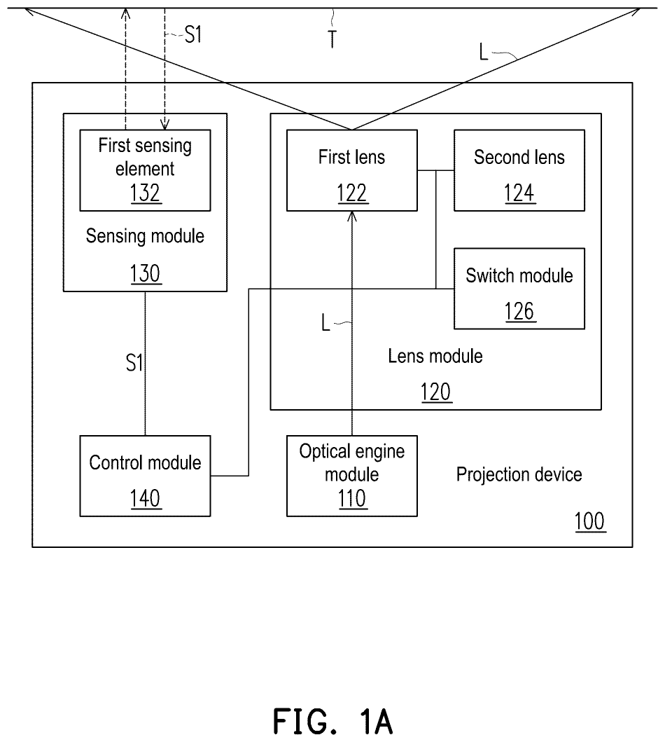

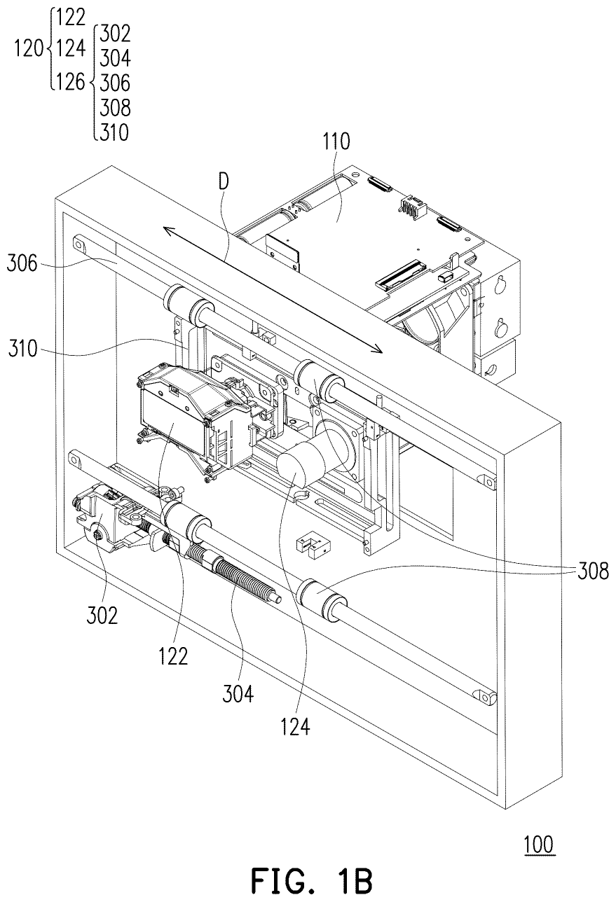

FIG. 1A and FIG. 1B are respectively a schematic block diagram and a schematic structural diagram illustrating a projection device using a first lens according to an embodiment of the disclosure. This embodiment provides a projection device 100, which includes an optical engine module 110, a lens module 120, a sensing module 130 and a control module 140. Wherein, the optical engine module 110 is configured to provide an image beam L, the lens module 120 is disposed on a transmission path of the image beam L, and is configured to project the image beam L to a projection target T outside the projection device 100. The projection target T is, for example, a screen or wall.

The optical engine module 110 is, for example, a combination of an illumination system, a plurality of light transmission elements, at least one light valve, and a plurality of different types of optical elements. The illumination system is, for example, composed of at least one or more light-emitting elements, wavelength converting elements, light uniformizing elements, light filter elements and a plurality of light splitting and combining elements. In other embodiments, the illumination system is composed of a plurality of light-emitting elements for emitting light with different wavelengths and a plurality of light splitting and combining elements. The illumination system is configured to provide and output light with different wavelengths to form an illumination beam. However, the disclosure does not limit the form and type of illumination system. The light valve is, for example, a reflective optical modulator such as a liquid crystal on silicon panel (LCOS panel) and a digital micro-mirror device (DMD). In some embodiments, the light valve may also be a transmissive optical modulator such as a transparent liquid crystal panel, an electro-optical modulator, a magneto-optical modulator, or an acousto-optical modulator (AOM). The disclosure does not limit the form and type of the light valve. The detailed steps and implementation manner of the method for converting the illumination beam into the image beam L by the light valve may be obtained from the common knowledge in the art with sufficient teaching, suggestion, and implementation description, so there will be no repetition.

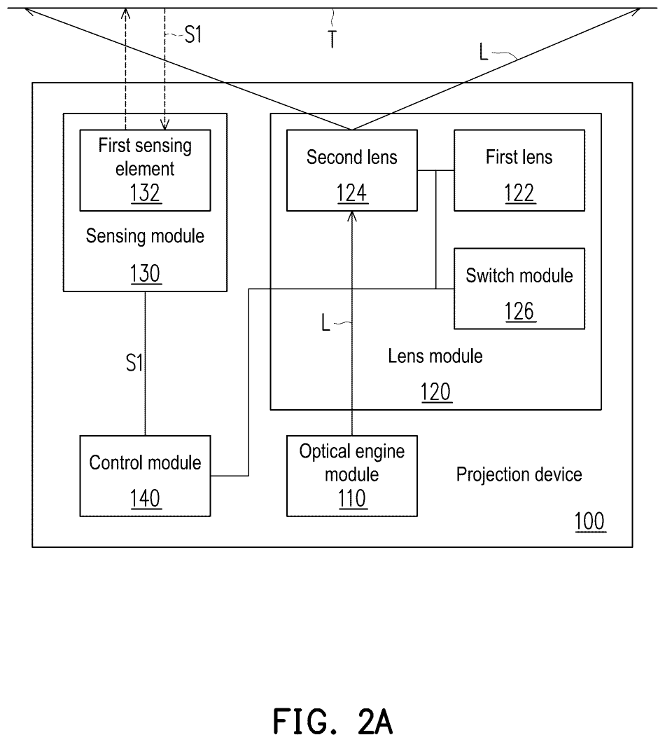

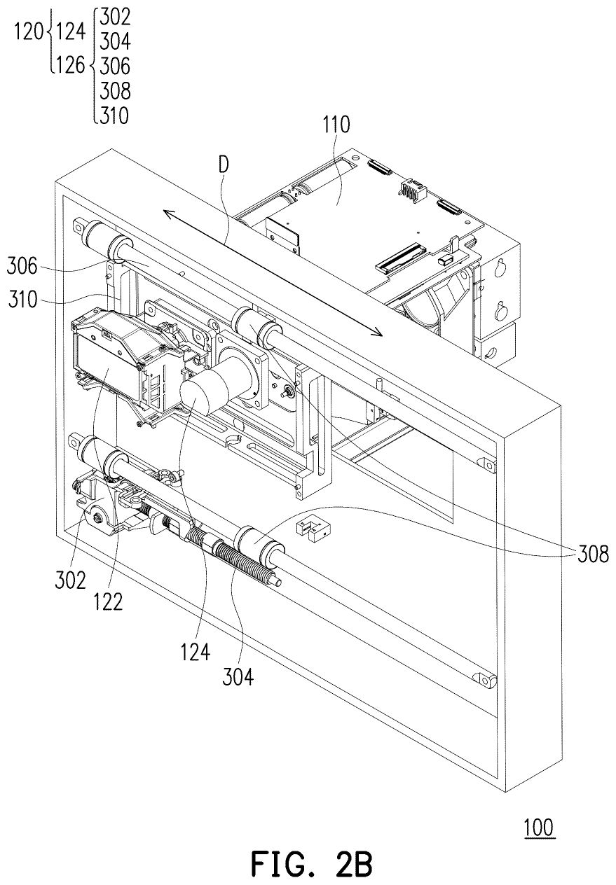

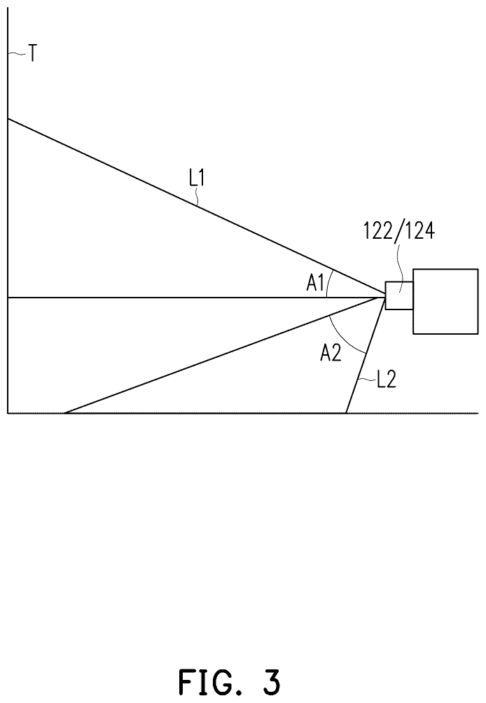

FIG. 2A and FIG. 2B are respectively a schematic block diagram and a schematic structural diagram illustrating a projection device using a second lens according to an embodiment of the disclosure. FIG. 3 is a schematic view of projections of the first lens and the second lens according to an embodiment of the disclosure. Please refer to FIG. 1A, FIG. 2A and FIG. 3 first. The lens module 120 includes a first lens 122, a second lens 124 and a switch module 126. In this embodiment, the throw ratio of the first lens 122 is greater than 0.3, and the throw ratio of the second lens 124 is less than 0.3, but the disclosure is not limited thereto. In other words, a beam angle A1 of the image beam L at the first lens 122 is different from a beam angle A2 of the image beam L at the second lens 124. For example, the first lens 122 is a telephoto lens composed of 2 to 6 lens elements, and is configured to provide an image beam to the projection target T to form a large-size display image. The second lens 124 is, for example, an ultra-short throw lens composed of 12 to 16 lens elements, which is configured in a small space with a short projection length or projected toward the ground, as shown in FIG. 3, and can be combined with smart products (such as robots) to use in public spaces (such as companies, malls or restaurants) to achieve the effect of mobile projection. The first projection path L1 is a path of the image beam L projected by the first lens 122, and the second projection path L2 is a path of the image beam L projected by the second lens 124. Therefore, in this embodiment, the beam angle A1 of the image beam L at the first lens 122 is smaller than the beam angle A2 of the image beam L at the second lens 124.

Please refer to FIG. 1B and FIG. 2B. The switch module 126 is connected to the first lens 122 and the second lens 124, and is configured to switch the positions of the first lens 122 and the second lens 124 relative to the optical engine module 110. For example, the switch module 126 includes mechanical elements like a driving element 302 (such as a motor), a screw rod 304, sliding rods 306, sliding bearings 308 and a clamping bearing platform 310. The driving element 302 is connected to the screw rod 304 and is configured to drive the screw rod 304 to push at least one sliding bearing 308 sleeved in the sliding rod 306. The plurality of sliding bearings 308 have a linkage relationship with each other, so that the plurality of sliding bearings 308 can move along the extending direction of the sliding rods 306. The at least one sliding bearing 308 is connected to the clamping bearing platform 310. Through the movement of the plurality of sliding bearings 308, the clamping bearing platform 310 can move along the extending direction of the sliding rods 306. The clamping bearing platform 310 is configured to carry the first lens 122 and the second lens 124. The first lens 122 and the second lens 124 are arranged along a switch direction D. The switch direction D is perpendicular to a direction in which the image beam L is incident on the lens module 120, and the switch direction D is parallel to the extending direction of the sliding rods 306. Specifically, when the first lens 122 and the second lens 124 are switched, the driving element 302 in the switch module 126 drives the clamping platform 310 to move the first lens 122 and the second lens 124 along the switch direction D. Therefore, when the first lens 122 is configured to project the image beam L, the first lens 122 is located on the transmission path of the image beam L from the optical engine module 110. The path of the image beam L is the first projection path L1 as shown in FIG. 3. The second lens 124 is not located on the transmission path of the image beam L from the optical engine module 110, so the first lens 122 and the optical engine module 110 are relatively close at this time. When the second lens 124 is configured to project the image beam L, the second lens 124 is located on the transmission path of the image beam L from the optical engine module 110. The path of the image beam L is the second projection path L2 as shown in FIG. 3. The first lens 122 is not located on the transmission path of the image beam L from the optical engine module 110, so the second lens 124 is relatively close to the optical engine module 110 at this time. The disclosure does not limit the form and type of the switch module 126. The detailed structure and implementation manner may be obtained from the common knowledge in the art with sufficient teaching, suggestion, and implementation description, so there will be no repetition.

The sensing module 130 includes a first sensing element 132. The first sensing element 132 may be a ranging sensor, such as a time-of-flight (ToF) sensor. The first sensing element 132 is configured to sense a distance between the projection device 100 and the projection target T to obtain a distance signal S1. The control module 140 is electrically connected to the sensing module 130 and the switch module 126 in the lens module 120. For example, the control module 140 includes at least one controller or processor, such as a microcontroller unit (MCU). The control module 140 is configured to receive the distance signal S1 from the first sensing element 132, and controls the switch module 126 according to the distance signal S1, so that the switch module 126 switches one of the first lens 122 and the second lens 124 to the transmission path of the image beam L. In this way, by installing the first lens 122 and second lens 124 with different optical conditions into the same projection device 100, and switching to use the appropriate lens according to the distance between the projection device 100 and the projection target T, the projection device 100 can eliminate the need to manually change the lens, and the convenience of use of the projection device 100 and its application fields are improved.

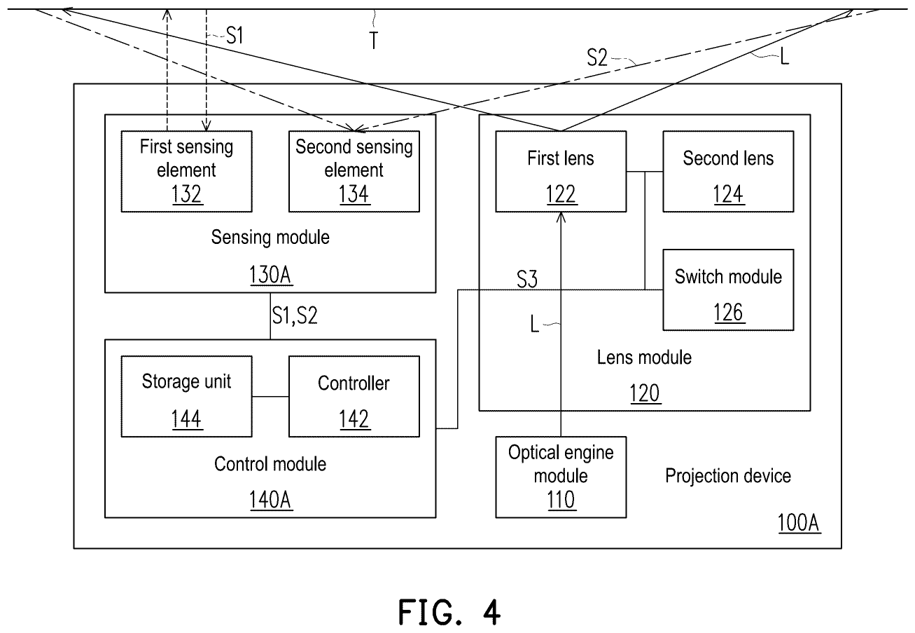

FIG. 4 is a schematic block diagram of a projection device according to another embodiment of the disclosure. Please refer to FIG. 4. A projection device 100A of this embodiment is similar to the projection device 100 shown in FIG. 1A. The difference between the two is that, in this embodiment, the sensing module 130A also includes a second sensing element 134, which is electrically connected to the control module 140A. The second sensing element 134 is, for example, a camera. The second sensing element 134 is configured to sense the image formed by the image beam L projected onto the projection target T to obtain an image sensing signal S2. The control module 140A is configured to adjust a focal length of the first lens 122 or a focal length of the second lens 124 according to the image sensing signal S2. Specifically, in this embodiment, the control module 140A further includes a controller 142, such as a microcontroller unit (MCU). The controller 142 is configured to receive the image sensing signal S2 from the second sensing element 134, and confirms the type of lens (i.e., the first lens 122 or the second lens 124) located on the transmission path of the image beam L according to the distance signal S1. After confirming the lens type located on the transmission path of the image beam L, the controller 142 selects a focus table corresponding to the lens type, generates a focus adjustment signal S3 according to the image sensing signal S2 and the focus table, and transmits the focus adjustment signal S3 to the lens module 120. The lens module 120 adjusts the focal length of the first lens 122 or the focal length of the second lens 124 according to the focus adjustment signal S3, for example, by driving elements such as a motor. For example, in this embodiment, the control module 140A further includes a storage unit 144, which is communicated with the controller 142 and configured to store the focus tables corresponding to the first lens 122 and the second lens 124. The storage unit 144 can be a hard disk or a cache memory, the disclosure is not limited thereto. However, in another embodiment, the focus tables of different types of lens can also be directly stored in the controller 142, the disclosure is not limited thereto. In this way, the effect of autofocus can be achieved.

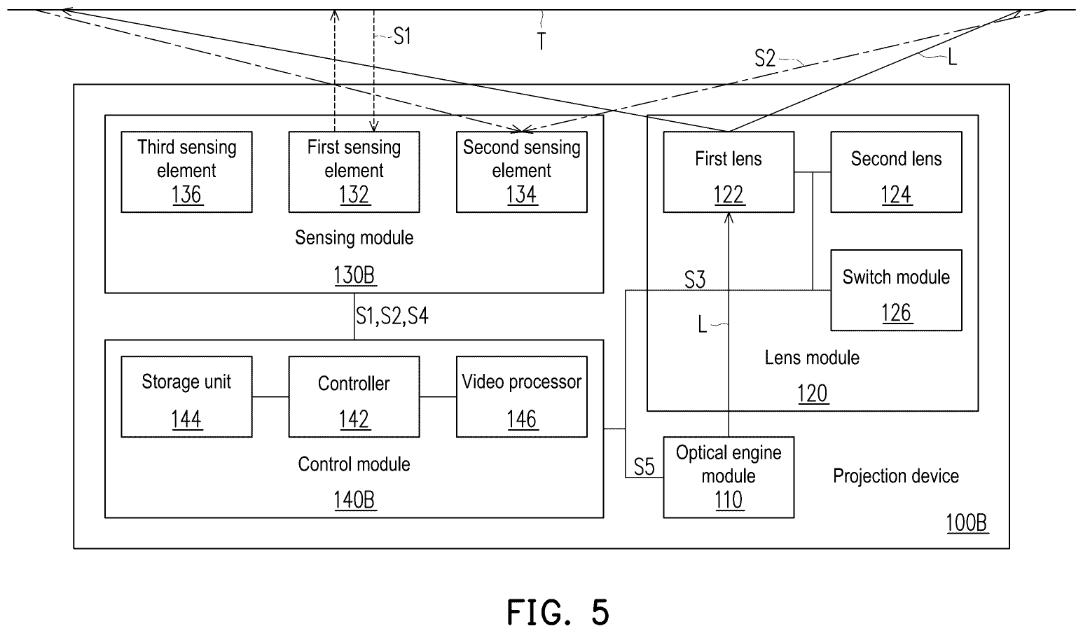

FIG. 5 is a schematic block diagram of a projection device according to another embodiment of the disclosure. Please refer to FIG. 5. A projection device 100B of this embodiment is similar to the projection device 100A shown in FIG. 4. The difference between the two is that, in this embodiment, the sensing module 130B further includes a third sensing element 136, which is electrically connected to the control module 140B. The third sensing element 136 is, for example, a gravity sensor (G-sensor) or a combination of a camera and a gravity sensor. The third sensing element 136 is configured to sense the position of the projection device 100B to obtain a position signal S4, such as the tilt angle of the projection device 100B. The control module 140B is configured to generate a correction compensation signal S5 according to the position signal S4 and transmit the correction compensation signal S5 to the optical engine module 110, so that the optical engine module 110 adjusts the image beam L according to the correction compensation signal S5, and corrects the shape of the image formed by the image beam L projected onto the projection target T. Specifically, the control module 140B includes the controller 142 and a video processor 146. The controller 142 is configured to receive the position signal S4 from the third sensing element 136, confirm the lens type (i.e., the first lens 122 or the second lens 124) on the transmission path of the image beam L according to the distance signal S1, and select the keystone correction table corresponding to the lens type. The video processor 146 is configured to receive the position signal S4 and the keystone correction table from the controller 142, generate the correction compensation signal S5 according to the position signal S4 and the keystone correction table, and transmit the correction compensation signal S5 to the optical engine module 110. Or, in another embodiment, the controller 142 is configured to confirm the lens type on the transmission path of the image beam L according to the distance signal S1, and select a keystone correction table corresponding to the lens type. The video processor 146 is configured to receive the position signal S4 from the third sensing element 136 and the keystone correction table from the controller 142, generate the correction compensation signal S5 according to the position signal S4 and the keystone correction table, and transmit the correction compensation signal S5 to the optical engine module 110. In addition, in any of the above embodiments, the control module 140B further includes a storage unit 144, which can be a hard disk or a cache memory, the disclosure is not limited thereto. The storage unit 144 is communicated with the controller 142, and is configured to store keystone correction tables corresponding to the first lens 122 and the second lens 124.

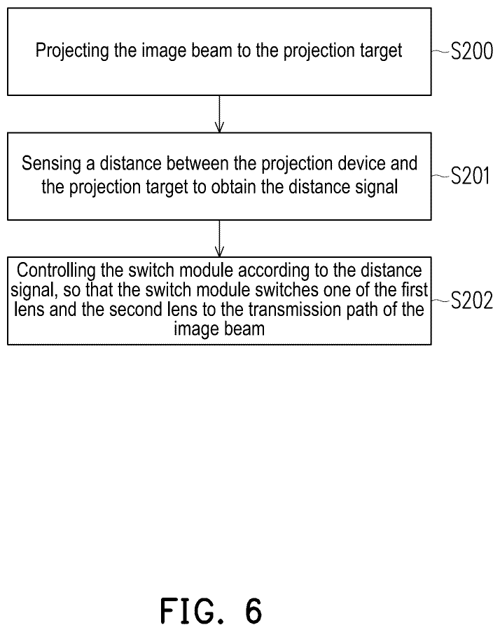

FIG. 6 is a flowchart of steps of a use method of a projection device according to an embodiment of the disclosure. Please refer to FIG. 6. This embodiment provides a use method of the projection device, which can be applied to any of the above embodiments. The following description applies to the projection device 100 shown in FIG. 1A. First, step S200 is executed to project the image beam L to the projection target T. Next, after the above step, step S201 is executed to sense a distance between the projection device 100 and the projection target T to obtain a distance signal S1. Finally, step S202 is executed to control the switch module 126 according to the distance signal S1, so that the switch module 126 switches one of the first lens 122 and the second lens 124 to the transmission path of the image beam L. In addition, the method of controlling the switch module 126 to move the first lens 122 and the second lens 124, the method of the automatic focusing of the first lens 122 and the second lens 124, and the keystone correction method of the image formed by the image beam L projected onto the projection target T are as mentioned above, so there will be no repetition.

To sum up, embodiments of the disclosure have at least one of the following advantages or effects. In the projection device and the use method thereof provided herein, the projection device comprise an optical engine module, a lens module, a sensing module and a control module. The lens module includes a first lens, a second lens and a switch module. The switch module connects the first lens and the second lens to switch the positions of the first lens and the second lens relative to the optical engine module. Therefore, by sensing a distance between the projection device and the projection target, the switch module can be controlled according to the distance signal, so that the switch module switches one of the first lens and the second lens to the transmission path of the image beam. In this way, by installing the first lens and second lens with different optical conditions into the same projection device, switching to use the appropriate lens according to the distance between the projection device and the projection target, the projection device can eliminate the need to manually change the lens, and the convenience of use of the projection device and its application fields are improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising an optical engine module, a lens module, a sensing module and a control module, wherein:
the optical engine module is configured to provide an image beam;
the lens module is configured on a transmission path of the image beam to project the image beam to a projection target outside the projection device, the lens module includes a first lens, a second lens and a switch module, the switch module connects the first lens and the second lens to switch the positions of the first lens and the second lens relative to the optical engine module;
the sensing module includes a first sensing element, the first sensing element is configured to sense a distance between the projection device and the projection target to obtain a distance signal; and
the control module is electrically connected to the sensing module and the switch module, the control module is configured to receive the distance signal from the first sensing element, and control the switch module according to the distance signal, so that the switch module switches one of the first lens and the second lens to the transmission path of the image beam.

2. The projection device according to claim 1, wherein a throw ratio of the first lens is greater than 0.3, and a throw ratio of the second lens is less than 0.3.

3. The projection device according to claim 1, wherein a beam angle of the image beam at the first lens is different from a beam angle of the image beam at the second lens.

4. The projection device according to claim 1, wherein when the first lens and the second lens are switched, the switch module moves the first lens and the second lens along a switch direction, and the switch direction is perpendicular to a direction in which the image beam incident on the lens module.

5. The projection device according to claim 1, wherein the sensing module further includes a second sensing element, the second sensing element is electrically connected to the control module, and configured to sense an image formed by the image beam is projected onto the projection target, to obtain an image sensing signal, the control module is further configured to adjust a focal length of the first lens or a focal length of the second lens according to the image sensing signal.

6. The projection device according to claim 5, wherein the control module includes a controller,
the controller is configured to receive the image sensing signal from the second sensing element, confirm a lens type on the transmission path of the image beam according to the distance signal, select a focus table corresponding to the lens type, generate a focus adjustment signal according to the image sensing signal and the focus table, and transmit the focus adjustment signal to the lens module, the lens module adjusts the focal length of the first lens or the focal length of the second lens according to the focus adjustment signal.

7. The projection device according to claim 6, wherein the control module further includes a storage unit, the storage unit is communicated with the controller, and configured to store the focus table corresponding to the first lens and the second lens.

8. The projection device according to claim 1, wherein the sensing module further includes a third sensing element, the third sensing element is electrically connected to the control module, and configured to sense a position of the projection device to obtain a position signal, the control module is further configured to generate a correction compensation signal according to the position signal and transmit the correction compensation signal to the optical engine module, so that the optical engine module adjusts the image beam according to the correction compensation signal to correct the shape of an image formed by the image beam is projected onto the projection target.

9. The projection device according to claim 8, wherein the control module includes a controller and a video processor, the controller is configured to receive the position signal from the third sensing element, confirm a lens type on the transmission path of the image beam according to the distance signal, select a keystone correction table corresponding to the lens type, the video processor is configured to receive the position signal and the keystone correction table from the controller, generate a correction compensation signal according to the position signal and the keystone correction table, and transmit the correction compensation signal to the optical engine module.

10. The projection device according to claim 9, wherein the control module further includes a storage unit, the storage unit is communicated with the controller, and configured to store the keystone correction tables corresponding to the first lens and the second lens.

11. The projection device according to claim 8, wherein the control module includes a controller and a video processor, the controller is configured to confirm a lens type on the transmission path of the image beam according to the distance signal, select a keystone correction table corresponding to the lens type, the video processor is configured to receive the position signal from the third sensing element and the keystone correction table from the controller, generate a correction compensation signal according to the position signal and the keystone correction table, and transmit the correction compensation signal to the optical engine module.

12. The projection device according to claim 11, wherein the control module further includes a storage unit, the storage unit is communicated with the controller, and configured to store the keystone correction tables corresponding to the first lens and the second lens.

13. A use method of a projection device, wherein the projection device is the projection device described in claim 1, the steps of the use method of the projection device comprising:
projecting the image beam to the projection target;
sensing the distance between the projection device and the projection target to obtain the distance signal; and
controlling the switch module according to the distance signal, so that the switch module switches one of the first lens and the second lens to the transmission path of the image beam.

14. The use method of the projection device according to claim 13, wherein the step of controlling the switch module according to the distance signal, so that the switch module switches one of the first lens and the second lens to the transmission path of the image beam further comprising:
moving the first lens and the second lens along a switch direction, the switch direction is perpendicular to a direction in which the image beam incident on the lens module.

15. The use method of the projection device according to claim 13, the steps of the use method of the projection device further comprising:
sensing an image formed by the image beam projected onto the projection target to obtain an image sensing signal; and
adjusting a focal length of the first lens or a focal length of the second lens according to the image sensing signal.

16. The use method of the projection device according to claim 15, the step of adjusting the focal length of the first lens or the focal length of the second lens according to the image sensing signal further comprising:
confirming a lens type on the transmission path of the image beam according to the distance signal, selecting a focus table corresponding to the lens type, generating a focus adjustment signal according to the image sensing signal and the focus table, and adjusting the focal length of the first lens or the focal length of the second lens according to the focus adjustment signal.

17. The use method of the projection device according to claim 13, the steps of the use method of the projection device further comprising:
sensing the position of the projection device to obtain a position signal; and
generating a correction compensation signal according to the position signal, adjusting the image beam according to the correction compensation signal to correct the shape of the image formed by the image beam is projected onto the projection target.

18. The use method of the projection device according to claim 17, wherein the step of generating the correction compensation signal according to the position signal further comprising:
confirming a lens type on the transmission path of the image beam according to the distance signal, selecting a keystone correction table corresponding to the lens type, and generating the correction compensation signal according to the position signal and the keystone correction table.
